(19) United States
(12) Patent Application Publication
(10) Pub. No.: US 2025/0261271 A1
(43) Pub. Date: Aug. 14, 2025

(54) DUAL MODE WIRELESS COMMUNICATION

(71) Applicant: WILDSTAR, LLC, Saratoga, CA (US)

(72) Inventor: Sien An Ong, Reuver (NL)

(73) Assignee: WILDSTAR, LLC, Saratoga, CA (US)

(21) Appl. No.: 18/977,078

(22) Filed: Dec. 11, 2024

Related U.S. Application Data
(60) Provisional application No. 63/552,369, filed on Feb. 12, 2024.

(51) Int. Cl. H04W 76/27

(52) U.S. Cl. CPC H04W 76/27

(57) ABSTRACT

The disclosed technology is generally directed to a wireless device. In one example of the technology, the wireless device includes a network modem and a controller. The network modem may connect with a first network in a first network mode and connect with a second network in a second network mode. The controller may control a connected state and an inactive state of the first network mode and the second network mode. The controller may switch the first network mode from the inactive state to the connected state when the second network mode is in the inactive state and switch the second network mode from the inactive state to the connected state when the first network mode is in the inactive state.

### CROSS REFERENCE TO RELATED APPLICATIONS

This application claims the benefit of U.S. Provisional Application Ser. No. 63/552,369, filed on Feb. 12, 2024, the disclosure of which is incorporated herein by reference.

### TECHNICAL FIELD

This disclosure is directed to wireless communication, and more particularly, to dual mode wireless communication, such as user equipment (UE) communication with terrestrial networks (TNs) and non-terrestrial networks (NTNs).

### BACKGROUND

Traditional satellite communication systems may not provide continuous connectivity to user equipment on the ground due to factors such as satellite movement, orbital constraints, and system maintenance. During periods when the satellite link is not actively engaged with the user equipment, there exists an opportunity for connecting to terrestrial networks. Existing solutions have two different set of resources for connecting with the satellite communication system, i.e., the non-terrestrial network, and the terrestrial network. The switching mechanism may require additional hardware, leading to increased costs and potential points of failure. The complexity of managing both non-terrestrial and terrestrial connections within a unified communication system can pose challenges.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one aspect, an exemplary embodiment of the present disclosure may provide a wireless device. The wireless device comprises a network modem and a controller. The network modem may be configured to connect with a first network in a first network mode and connect with a second network in a second network mode. The controller may be configured to control a connected state and an inactive state of the first network mode and the second network mode. The controller may be further configured to switch the first network mode from the inactive state to the connected state when the second network mode is in the inactive state and switch the second network mode from the inactive state to the connected state when the first network mode is in the inactive state.

In an exemplary embodiment of the present disclosure, the first network may be a terrestrial network, and the second network may be a non-terrestrial network. Further, the wireless device may be a user equipment.

In an exemplary embodiment of the present disclosure, the first network mode and the second network mode are capable of being in the inactive state simultaneously. The controller may be further configured to switch a mode of the controller from an active mode to a sleep mode when the first network mode and the second network mode are simultaneously in the inactive state.

In one embodiment, when one of the first network mode and the second network mode initiates switching from the inactive state to the connected state, the controller may be configured to switch a mode of the controller from the sleep mode to the active mode. Additionally, after switching to the active mode the controller may switch one of the first network mode and the second network mode from the inactive state to the connected state.

In an exemplary embodiment of the present disclosure, the wireless device may further comprise a memory. In some implementations, the memory may be configured to store at least one of first network data and first modem configuration associated with the first network and second network data and second modem configuration associated with the second network.

In an exemplary embodiment of the present disclosure, before switching to the sleep mode, the controller may be configured to store at least one of the first network data, and the first modem configuration, and the second network data, and the second modem configuration in the memory. In some implementations, the memory may be a flash memory. Additionally, before switching to the active mode, the controller may be configured to retrieve at least one of the first network data, and the first modem configuration, and the second network data, and the second modem configuration from the memory.

In an exemplary embodiment of the present disclosure, the controller may be further configured to provide a connected state schedule of the second network mode to the first network mode. Further, the first network modem may be configured to provide the connected state schedule of the second network mode to a scheduler of the first network. In some implementations, the scheduler of the first network may be configured to schedule, based on the connected state schedule of the second network mode, a connected state schedule of the first network mode such that the connected state of the first network mode and the connected state of the second network mode are non-overlapping.

In an exemplary embodiment of the present disclosure, the wireless device may comprise a set of shared resources. The network modem in the first network mode is further configured to access the set of shared resources to connect with the first network, and the network modem in the second network mode is further configured to access the set of shared resources to connect with the second network. The controller may be configured to non-simultaneously grant access of the set of shared resources to the network modem to connect with the first network and the second network.

In another aspect, an exemplary embodiment of the present disclosure may provide a method operating a wireless device comprising a controller and a network modem that is connectable with a first network and a second network. Implementations of the described techniques may include hardware, or a non-transitory, a computer readable medium, etc. Other embodiments of this aspect include corresponding computer systems, apparatus, and computer programs recorded on one or more computer storage devices, each configured to perform the actions of the methods. The system may include one or more computers that can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Implementations may include one or more of the following features.

In an exemplary embodiment of the present disclosure, the method may include connecting either the network modem in a first network mode with the first network or the network modem in a second network mode with the second network and controlling a connected state and an inactive state of the first network mode and the second network mode by the controller of the wireless device. The method may further include switching the first network mode from the inactive state to the connected state when the second network mode is in the inactive state and switching the second network mode from the inactive state to the connected state when the first network mode is in the inactive state.

Further aspects, features, applications and advantages of the disclosed technology, as well as the structure and operation of various examples, are described in detail below with reference to the accompanying drawings. It is noted that the disclosed technology is not limited to the specific examples described herein. Such examples are presented herein for illustrative purposes only. Additional examples will be apparent to persons skilled in the relevant art(s) based on the teachings contained herein.

### BRIEF DESCRIPTION OF THE SEVERAL VIEWS OF THE DRAWINGS

For a better understanding of the present disclosure, non-limiting and non-exhaustive examples of the present disclosure are described with reference to the following drawings, in which:

FIG. 1A is a simplified diagram illustrating a dual mode communication system in which aspects of the technology may be employed;

FIG. 1B is a block diagram of an exemplary base station in which aspects of the technology may be employed;

FIG. 1C is a block diagram of an exemplary phased array antenna system in which aspects of the technology may be employed;

FIG. 2 is a block diagram of an exemplary user equipment (UE) in which aspects of the technology may be employed;

FIG. 3A is a block diagram illustrating one example of a state transfer procedure of a UE according to aspects of the disclosed technology;

FIG. 3B is a timing diagram illustrating one example of a duration of a state transfer procedure of a UE according to aspects of the disclosed technology;

FIG. 4A is another block diagram illustrating another example of the state transfer procedure of the UE according to aspects of the disclosed technology;

FIG. 4B is a process flow diagram illustrating one example of process flow during the state transfer procedure of the UE according to aspects of the disclosed technology;

FIGS. 5A-5C, collectively, represent a flowchart illustrating one example of a method of operating a wireless device according to aspects of the disclosed technology; and

FIG. 6 is a diagram illustrating one example of a computing device in which aspects of the technology may be practiced.

In the drawings, similar reference numerals refer to similar parts throughout the drawings unless otherwise specified. These drawings are not necessarily drawn to scale.

### DETAILED DESCRIPTION

Technologies are provided for establishing a dual mode wireless communication of a user equipment (UE) with a non-terrestrial network (NTN) and a terrestrial network (TN). Technologies are also provided for switching the communication of the UE with the TN and the NTN while using same set of shared resources. The specification and accompanying drawings disclose one or more exemplary embodiments that incorporate the features of the present disclosure. The scope of the present disclosure is not limited to the disclosed embodiments. The disclosed embodiments merely exemplify the present disclosure, and modified versions of the disclosed embodiments are also encompassed by the present disclosure. Embodiments of the present disclosure are defined by the claims appended hereto.

It is noted that any section/subsection headings provided herein are not intended to be limiting. Any embodiments described throughout this specification, and disclosed in any section/subsection may be combined with any other embodiments described in the same section/subsection and/or a different section/subsection in any manner.

Implementations of the techniques described herein may include hardware, a method or process, or a non-transitory computer readable medium, etc. Other embodiments of this aspect include corresponding computer systems, apparatus, and computer programs recorded on one or more computer storage devices, each configured to perform the actions of the methods. The system may include one or more computers that can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Implementations may include one or more of the following features. Prior to describing exemplary embodiments that incorporate the features of the present disclosure, a discussion of security concepts that are appliable to the exemplary embodiments will be provided.

A wireless communications system may be an NTN including a satellite (e.g., a non-geostationary satellite) that includes a base station that is configured to communicate with multiple user equipment (UE) in a given coverage area. Further, the wireless communications system may be a TN including a ground base station on the Earth that is configured to communicate with multiple user equipment (UE) in a given coverage area. In this regard, the ground base station serves or acts as a network node. Some techniques for switching wireless communication of the UE between the TN and the NTN may need to be improved.

During an inactive state of the UE, the UE attempts to establish a connection with a network, such as the NTN, and it transmits a Physical Random Access Channel (PRACH) signal to a base station of the network to request access. Upon successful establishment of the connection, data transfer may be done between the UE and the satellite. Further, when the US is in an inactive state and the UE is not connected to the NTN, the UE may attempt to establish connection with the TN.

### Technical Problem with Conventional Dual Mode Wireless Communication Procedures

In conventional dual mode communication systems, the UE may include different set of resources for connection with the NTN and the TN. For example, one set of an antenna, a transceiver, a controller, and a memory for connecting with the NTN and another set of an antenna, a transceiver, a controller, and a memory for connecting with the TN. Thus, the resources required for the UE to connect with the NTN and the TN increases. Further, the conventional dual mode communication systems are not capable of managing the switching between the NTN and the TN communication in an efficient manner. Additionally, low earth orbit (LEO) communication satellites are equipped with a base station and serve as network nodes of the network. These satellites revolve around the Earth (or other body) at high speeds. Each LEO communication satellite transmits a beam that covers a specific coverage area or circular footprint (e.g., on the Earth's surface). The coverage area of a beam in Low Earth Orbit (LEO) can vary depending on several factors, including the satellite's altitude, the frequency it operates at, and the antenna design. To explain further, the coverage area can vary from hundreds to over tens of thousands square kilometers (km²). The altitude of an LEO satellite could range from about 180 kilometers to 2,000 kilometers above the Earth's surface. The higher the altitude, the larger the coverage area, but also the higher the latency. The number of cells within the coverage area of a LEO communication satellite depends on the satellite's design and the specific purpose of the satellite. In a simple scenario, a single satellite can have one beam covering its entire footprint, but in more advanced systems, a single satellite can have multiple spot beams for more focused coverage, each covering a portion of the satellite's coverage area, which may also be referred to as a cell. The radius of each cell within the satellite's coverage area depends on the satellite's altitude, frequency band, and the antenna design. Depending on the implementation, the cell radius could range from ten or less kilometers to over a hundred kilometers.

As such, a given base station mounted on a satellite has a relatively short time window of setting up a communication link with a ground-based UE (e.g., terminal or device). Thus, it is desirable for the switching of the UE from the TN to the NTN communication to be efficient to avoid missing the short time window of setting up the communication link with the satellite.

To circumvent this problem, one approach is to start switching from the NTN communication to the TN communication when the NTN mode of the UE is in the RRC IDLE, RRC INACTIVE or radio connection failed states. Further, it would be desirable to reduce usage of hardware resources utilized during the NTN and TN communication by using a set of shared resources at the UE, such as a single antenna, a single transceiver, a single controller, and a single memory for connecting with the TN and the NTN.

In accordance with the disclosed embodiments, the UE includes a joint controller to manage the communication and switching of the UE in the NTN mode and the TN mode. In particular, the joint controller is disclosed that may help ensure that the UE is in connection with the TN or the NTN non simultaneously and utilizes the same set of resources for the NTN and the TN communication.

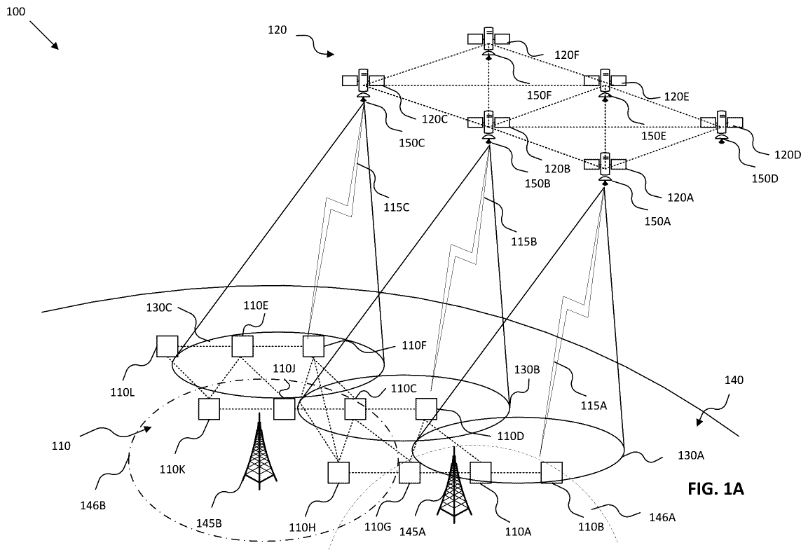

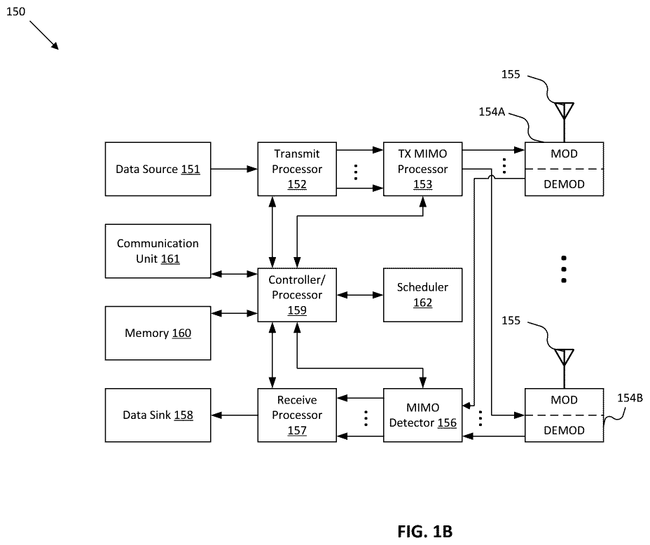

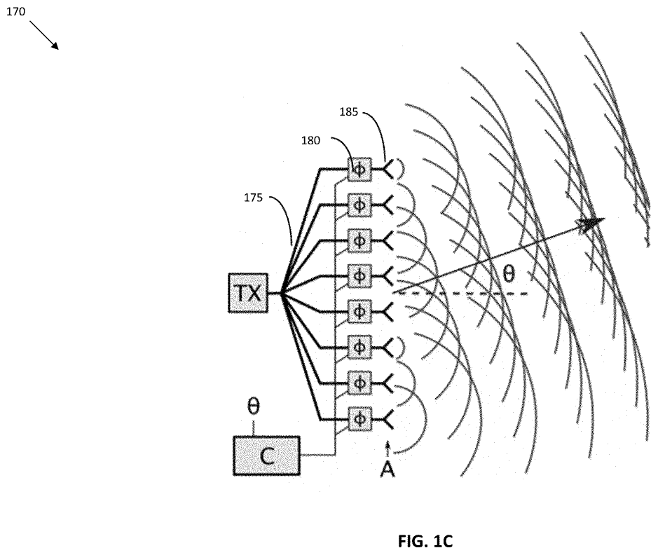

Having given this description of a system for dual mode wireless communication between the UE and the base station of the satellite in the NTN and the ground base station in the TN that can be applied within the context of the present disclosure, technologies will now be described with reference to FIGS. 1-6 for dual mode wireless communication.

FIG. 1A is a simplified diagram illustrating a dual mode communication system 100 in which aspects of the technology may be employed. The system 100 includes multiple user equipment (UE) 110 that are in communication with each other, a constellation of satellites 120 that are in communication with one or more of the UE 110, and multiple ground base stations 145 that are in communication with one or more of the UE 110. The constellation of satellites 120 includes a group of artificial satellites that are positioned in a number of different orbits around the Earth 140 to provide specific services or coverage. For instance, the satellites 120 may work together to offer communication, navigation, or remote sensing services to a wide geographic area on Earth. The constellation of satellites 120 may include any number of satellites to ensure global coverage and to provide redundancy in case of failure. In one embodiment, the satellites 120 may make up a 5G Non-Terrestrial Network, such as a Low Earth Orbit (LEO) constellation, and each satellite 120 includes a base station 150 that acts or serves as a network node of the non-terrestrial network. The ground base stations 145 may make up a Terrestrial Network and each ground base station 145 acts or serves as a network node of the Terrestrial Network. In some cases, the system 100 may support enhanced broadband communications, ultra-reliable (e.g., mission critical) communications, low latency communications, or communications with low-cost and low-complexity devices. It should be appreciated that such satellite constellations can be arranged in different configurations, including low Earth orbit (LEO), medium Earth orbit (MEO), or geostationary orbit (GEO), depending on the intended application and the desired level of coverage and service.

Each of the satellites 120 is an artificial object placed in orbit around a celestial body, often referring to Earth 140. Each satellite typically includes various components such as a communication or scientific payload, power systems (such as solar panels), propulsion for orbit adjustments, and communication equipment to transmit and receive data to and from Earth 140. Each satellite, e.g., the satellite 120A, may include a base station, e.g., the base station 150A, that may wirelessly communicate with UEs 110 via one or more antennas. The base stations 150 of the satellites 120 may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. The base stations 150 of the satellites 120 may be of different types (e.g., macro or small cell base stations). The UEs 110 described herein may be able to communicate with various types of base stations and network equipment including macro eNBs, small cell eNBs, gNBs, relay base stations, and the like.

Each base station, such as the base station 150A of satellite 120A, may be associated with a particular geographic coverage area, for example, geographic coverage area 130A in which communications with various UEs, such as the UEs 110A and 110B is supported. For sake of simplicity, FIG. 1A shows a simplified representation that includes three geographic coverage areas 130, which may be referred to herein as a first geographic coverage area 130A, a second geographic coverage area 130B, and a third geographic coverage area 130C; however, it should be appreciated that each base station 150 includes an associated geographic coverage area. Each base station may provide communication coverage for a respective geographic coverage area via communication links 115, and communication links 115 between a base station 150 of satellite 120 and a UE 110 may utilize one or more carriers. The communication links may include upstream transmissions from the UE 110 to the base station 150 of satellite 120, or downstream transmissions from the base station 150 of satellite 120 to the UE 110. Downstream transmissions may also be called downlink or forward link transmissions while upstream transmissions may also be called uplink or reverse link transmissions.

Although not shown in FIG. 1A, each geographic coverage area 130 of a base station 150 may be divided into sectors (not shown) each making up a portion of the geographic coverage area 130, and each sector may be associated with a cell. For example, each base station may provide communication coverage for a macro cell, a small cell, a hot spot, or other types of cells, or various combinations thereof. In some examples, the base stations may be non-stationary and therefore provide communication coverage for a moving geographic coverage area 130. In some examples, different geographic coverage areas 130 associated with different technologies may overlap, and the overlapping geographic coverage areas 130 associated with different technologies may be supported by the same base station or by different base stations. The system 100 may include, for example, a heterogeneous 5G network in which different types of base stations provide coverage for various geographic coverage areas 130.

The term “cell” refers to a logical communication entity used for communication with a base station (e.g., over a carrier) or a satellite beam, and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 130 (e.g., a sector) over which the logical entity operates.

Each of the ground base stations 145 may wirelessly communicate with UEs 110 via one or more antennas. The ground base stations 145 may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. The ground base stations 145 may be of different types (e.g., macro or small cell base stations). The UEs 110 described herein may be able to communicate with various types of ground base stations and network equipment including macro eNBs, small cell eNBs, gNBs, relay base stations, and the like.

Each ground base station, such as the ground base station 145A, may be associated with a particular coverage area, for example, coverage area 146A in which communications with various UEs, such as the UEs 110A, 110B, and 110G is supported. For sake of simplicity, FIG. 1A shows a simplified representation that includes two coverage areas 146, which may be referred to herein as a first coverage area 146A and a second coverage area 146B; however, it should be appreciated that each ground base station 145 includes an associated coverage area. Each ground base station may provide communication coverage for a respective coverage area.

The UEs 110 may be deployed at different locations in a geographic coverage area 130 or coverage area 146 that includes, for example, a forest, an agricultural land, or the like. In one embodiment, for example, the UEs 110 are positioned at the different locations in certain geographic area to provide sensor coverage over part of or substantially all of the area. The UEs 110 may also be referred to as a mobile device, a wireless device, a remote device, a handheld device, or a subscriber device, or some other suitable terminology, where the “device” may also be referred to as a unit, a station, a terminal, or a client. The UE 110 may also be a personal electronic device such as a cellular phone, a personal digital assistant (PDA), a tablet computer, a laptop computer, or a personal computer. In some examples, the UE 110 may also refer to a wireless local loop (WLL) station, an Internet of Things (IoT) device, an Internet of Everything (IoE) device, or an MTC device, or the like, which may be implemented in various articles such as appliances, vehicles, meters, or the like.

In an embodiment, some or all of the UEs 110 may be implemented as MTC or IoT devices, which may be low cost or low complexity devices, and may provide for automated communication between machines (e.g., via Machine-to-Machine (M2M) communication). M2M communication or MTC may refer to data communication technologies that allow devices to communicate with one another or a base station of a satellite without human intervention. In some examples, M2M communication or MTC may include communications from devices that integrate sensors or meters to measure or capture information and relay that information to a central server or application program that can make use of the information or present the information to humans interacting with the program or application. The UEs 110 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The UEs 110 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for the UEs 110 include entering a power saving “deep sleep” mode when not engaging in active communications, or operating over a limited bandwidth (e.g., according to narrowband communications). In some cases, the UEs 110 may be designed to support critical functions (e.g., mission critical functions), and the system 100 may be configured to provide ultra-reliable communications for these functions.

In some embodiments, a UE, such as the UE 110A may also be able to communicate directly with other UEs, such as the UE 110B (e.g., using a peer-to-peer (P2P) or device-to-device (D2D) protocol). One or more of a group of UEs 110 utilizing D2D communications may be within the geographic coverage area 130 of a base station, such as the geographic coverage area 130A of base station 150 of satellite 120A. Other UEs 110 in such a group may be outside the geographic coverage area 130A of the base station 150 of satellite 120A or be otherwise unable to receive transmissions from the base station 150 of satellite 120A. In some cases, groups of UEs 110 communicating via D2D communications may utilize a one-to-many (1:M) system in which each UE 110 transmits to every other UE 110 in the group. In some cases, a base station facilitates the scheduling of resources for D2D communications. In other cases, D2D communications are carried out between UEs 110 without the involvement of a base station.

In some embodiments, the UEs 110 and the satellites 120 that make up the constellation are designed so that they are capable of non-line-of-sight (NLOS) communications with one another. When communication devices, such as the UEs 110 and based stations implemented at satellites 120, are capable of NLOS communication, the device can establish communication links 115 even when there are obstacles or obstructions between the transmitter and the receiver. In traditional line-of-sight communication, a clear and unobstructed path is needed between the transmitting and receiving antennas for reliable signal transmission. By contrast, NLOS communication allows signals to propagate and reach the receiver even if there are buildings, trees, terrain features, or other obstacles in the way. NLOS communication is particularly important, for example, in urban environments, dense foliage, indoor settings, and situations where direct line-of-sight paths are blocked.

The system 100 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 110 located indoors or under some obstruction or blockage. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

The system 100 may further operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that can tolerate interference from other users.

The system 100 may further operate in an extremely high frequency (EHF) region of the spectrum (e.g., from 30 GHz to 300 GHz), also known as the millimeter band. In some examples, the system 100 may support millimeter wave (mmW) communications between UEs 110 and base stations of satellites 120, and EHF antennas of the respective devices may be even smaller and more closely spaced than UHF antennas. In some cases, this may facilitate use of antenna arrays within a UE 110. However, the propagation of EHF transmissions may be subject to even greater atmospheric attenuation and shorter range than SHF or UHF transmissions. Techniques disclosed may be employed across transmissions that use one or more different frequency regions, and designated use of bands across these frequency regions may differ by country or regulating body.

In some cases, the system 100 may utilize both licensed and unlicensed radio frequency spectrum bands. For example, the system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 150 of satellites 120 and UEs 110 may employ listen-before-talk (LBT) procedures to ensure a frequency channel is clear before transmitting data. In some cases, operations in unlicensed bands may be based on a CA configuration in conjunction with CCs operating in a licensed band (e.g., LAA). Operations in unlicensed spectrum may include downstream transmissions, upstream transmissions, peer-to-peer transmissions, or a combination of these. Duplexing in unlicensed spectrum may be based on frequency division duplexing (FDD), time division duplexing (TDD), or a combination of both.

In some examples, the base stations 150 and/or UEs 110 may be equipped with multiple antennas, which may be used to employ techniques such as transmit diversity, receive diversity, multiple-input multiple-output (MIMO) communications, or beamforming. For example, the system 100 may utilize a transmission scheme between a transmitting device (e.g., a base station 150 or a UE 110) and a receiving device (e.g., a UE 110 or a base station 150), where the transmitting device is equipped with multiple antennas and the receiving devices are equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

### User Equipment

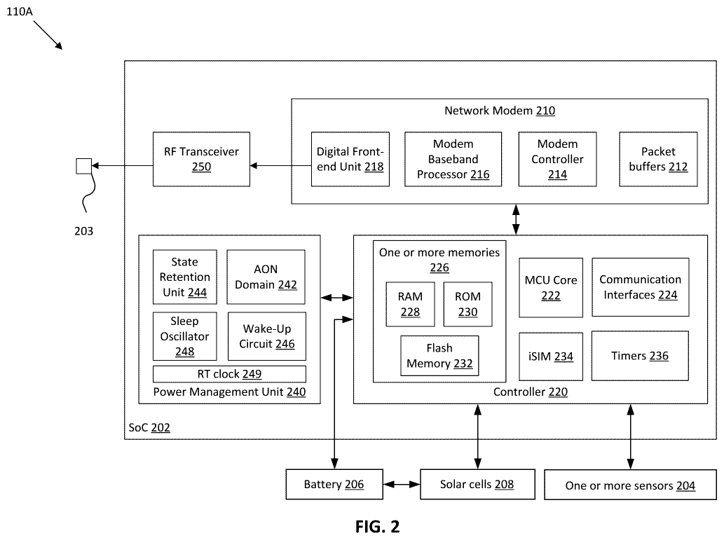

As shown in FIG. 2, each of the UE 110, for example, a first UE 110A, may include a system-on-chip (SoC) 202, one or more antennas 203, one or more sensors 204, a battery 206, and solar cells 208. The SoC 202 includes a network modem 210, a controller 220, a power management unit (PMU) 240, and a radio frequency (RF) transceiver 250. The network modem 210 may correspond to a network modem. In one embodiment, the network modem 210 may be a dual-mode network modem and may be configured to connect to a first network in a first network mode and connect to a second network in a second network mode. In one non-limiting embodiment of the present disclosure, the first network may be a terrestrial network (TN) and the second network may be a non-terrestrial network (NTN). Similarly, the first network mode may be a TN mode and the second network mode may be an NTN mode. Each network mode, such as the TN mode or the NTN mode, may be in one of: a connected state or an inactive state. When the TN mode is in the connected state, the UE 110 may be connected to the TN for communication and when the NTN mode is in the connected state, the UE 110 may be connected to the NTN for communication. Further, when the TN mode is in the inactive state, the UE 110 may be disconnected from the TN and when the NTN mode is in the inactive state, the UE 110 may be disconnected to the NTN.

The network modem 210 may include packet buffers 212, modem controller 214, modem baseband processor 216, and a digital frontend unit 218. The packet buffers 212 may correspond to storage areas designed to temporarily hold incoming and outgoing data packets. Incoming data packets from the communication medium (such as the internet) may be stored in the packet buffers 212 before being processed by the network modem 210. Outgoing data packets generated by the network modem 210 may also be temporarily stored in the packet buffers 212 before being transmitted. The modem controller 214 may be configured to coordinate the overall operation of the network modem 210. For example, the modem controller 214 may co-ordinate the dual mode operation of the modem by connecting with either one of the TN or the NTN. The modem controller 214 may be configured to interpret commands from higher-level software or the network, coordinate activities of the modem's hardware components, and handle tasks such as modulation/demodulation, error correction, and overall communication protocol management.

The modem baseband processor 216 may be configured to handle the signal processing tasks in the network modem 210. The modem baseband processor 216 may operate on the baseband signals, which are the original signals before modulation, demodulation, and other radio frequency (RF) processing. In one embodiment, the modem baseband processor 216 may be configured to perform tasks such as channel encoding/decoding, modulation/demodulation, error correction, and signal equalization and transform digital data into analog signals for transmission and vice versa to ensure reliable communication over the communication medium. The digital front-end unit 218 may be an interface between the analog signals in the communication medium and the digital processing components of the network modem 210. The digital front-end unit 218 may be configured to perform functions such as analog-to-digital conversion (ADC), digital-to-analog conversion (DAC), and managing the interface with the one or more antennas 203 and the RF transceiver 250.

The controller 220 may include an MCU core 222, communication interfaces 224, one or more memories 226, an integrated subscriber identity module (iSIM) 234, and timers 236. The MCU core 222 is a central processing unit (CPU) of the controller 220. The MCU core 222 may be configured to execute instructions stored in memory, perform calculations, control program flow, and manage the overall operation of the controller 220. The communication interfaces 224 may be configured to facilitate the exchange of data between the controller 220 and external devices or other microcontrollers. Examples of the communication interfaces may include, but are not limited to, Universal Asynchronous Receiver-Transmitter (UART), Serial Peripheral Interface (SPI), Inter-Integrated Circuit (I2C), Controller Area Network (CAN), Universal Serial Bus (USB), Quad Serial Peripheral Interface (QSPI), General-Purpose Input/Output (GPIO), Inter-IC Sound Bus (I2S), and Auxiliary port analog-to-digital/digital-to-analog (Aux AD/DA). The communication interfaces 224 may enable the controller 220 to connect and exchange information with one or more sensors 204, actuators, displays, memory devices, and other external peripherals.

The one or more memories 226 in the controller 220 include various types such as a Random Access Memory (RAM) 228, a Read-Only Memory (ROM) 230, and a Flash memory 232. The Flash memory 232 may be configured to store a program code that the controller 220 may execute. In one non-limiting embodiment of the present disclosure, the Flash memory 232 may be configured to store at least one of first network data, i.e., TN data, and first modem configuration associated with the TN and second network data, i.e., NTN data, and second modem configuration associated with the NTN. The first data or TN data corresponds to data packets that are to be transferred to or received from external devices of the TN during the TN mode by the UE 110. The first modem configuration associated with the TN indicates configuration instructions for the network modem 210 to operate in the TN mode. Similarly, the second data or NTN data corresponds to data packets that are to be transferred to or received from external devices of the NTN during the NTN mode by the UE 110. The second modem configuration associated with the NTN indicates configuration instructions for the network modem 210 to operate in the NTN mode.

The RAM 228 may provide volatile storage for data and variables during program execution and may be a static RAM (SRAM) with a SRAM retention portion. The ROM 230 may be utilized for non-volatile data storage that persists even when the controller 220 is powered off. The iSIM 234 may be an embedded SIM card within the controller 220, eliminating the need for a physical SIM card. The iSIM 234 may be configured to securely store subscriber identity information of the UE 110 required for cellular communication. The timers 236 may be dedicated hardware components that measure time intervals or generate precise timing events. The timers 236 may be configured to generate Pulse Width Modulation (PWM) signals, control delays, and manage time-related operations. The timers 236 may be utilized for tasks such as generating accurate time delays, measuring sensor input intervals, controlling motor speed through PWM, and maintaining real-time clock functions.

In one embodiment of the present disclosure, the controller 220 may be configured to control the connected state and the inactive state of the first network mode, i.e., the TN mode, and the second network mode, i.e., the NTN mode. Further, the controller 220 may be configured to switch the TN mode from the inactive state to the connected state when the NTN mode is in the inactive state and switch the NTN mode from the inactive state to the connected state when the TN mode is in the inactive state. In an exemplary embodiment of the present disclosure, the TN mode and the NTN mode are capable of being in the inactive state simultaneously. The controller 220 may be further configured to switch a mode of the controller 220 from an active mode to a sleep mode when the TN mode and the NTN mode are simultaneously in the inactive state. In a non-limiting embodiment, the controller 220 is switched from the active mode to the sleep mode to save power and manage power efficiently for various operations of the UE 110.

In an exemplary embodiment of the present disclosure, before switching to the sleep mode, the controller 220 may be configured to store at least one of the TN data, and the first modem configuration, and the NTN data, and the second modem configuration in a memory. In some implementations, the memory may be the Flash memory 232. In the conventional dual mode communication systems, the TN data and the first modem configuration associated with the TN are stored in a first memory and the NTN data and the second modem configuration associated with the NTN are stored in a second memory different from the first memory. In contrast, in the present disclosure both the TN data and the NTN data and the first and second modem configurations associated with the TN and the NTN are stored in a single shared memory, i.e., the Flash memory 232. The Flash memory 232 may act as a shared memory for the TN mode and the NTN mode of the controller 220 for communicating with the TN and the NTN. Thus, sharing of resources, such as the memory, for both the TN mode and the NTN mode reduces a requirement of a separate memory for each of the TN and NTN modes.

In one scenario, when one of the TN mode and the NTN mode initiates switching from the inactive state to the connected state, the controller 220 may be configured to switch a mode of the controller 220 from the sleep mode to the active mode. Before switching to the active mode, the controller 220 may be configured to retrieve at least one of the TN data, and the first modem configuration, and the NTN data, and the second modem configuration from the Flash memory 232. The TN data, and the first modem configuration, and the NTN data, and the second modem configuration in the Flash memory 232 enables the network modem 210 to resume the operation in either the TN mode or the NTN mode and maintain a track of data transferred via the TN or the NTN. Additionally, after switching to the active mode the controller 220 may switch one of the TN mode and the NTN mode from the inactive state to the connected state.

In an exemplary embodiment of the present disclosure, the controller 220 may be further configured to provide a connected state schedule of the NTN mode to the TN mode. In an exemplary embodiment of the present disclosure, the connected state schedule of the NTN mode may include RACH opportunities available for the UE 110 to establish connection with the satellites 120 for NTN communication. Further, the network modem 210 may be configured to provide the connected state schedule of the NTN mode to a scheduler of the TN. In some implementations, the scheduler of the TN may be configured to schedule, based on the connected state schedule of the NTN mode, a connected state schedule of the TN mode such that the connected state of the TN mode and the connected state of the NTN mode are non-overlapping.

The PMU 240 is a specialized integrated circuit or subsystem within the SoC 202 that may be configured to manage and optimize power consumption. The PMU 240 may efficiently distribute and regulate power to various components within the SoC 202, ensuring that power is delivered in a controlled manner to meet performance requirements while reducing and/or minimizing energy consumption. The PMU 240 includes an always on (AON) domain 242, a state retention unit 244, a wake-up circuit 246, a sleep oscillator 248, and a real time (RT) clock 249.

The AON domain 242 is a subset of the PMU 240 that may be configured to remain powered even when the rest of the SoC 202 is in a low-power or sleep mode. The AON domain 242 may drive components that maintain important functionalities that should operate continuously (or nearly continuously), such as real-time clocks (RTCs), low-power sensors, or circuits responsible for monitoring external inputs. The state retention unit 244 may be configured to preserve or retain system states or data when the controller 220 transitions between power states, especially from the active state to a low-power state or the sleep mode and vice versa. The state retention unit 244 may retain the system states to maintain the continuity of certain operations or retain information required for a quick and seamless return to full functionality.

The wake-up circuit 246 may be configured to transition the controller 220 from a low-power or sleep mode to an active state. The wake-up circuit 246 may detect external events or signals, such as user inputs, interrupts, or specific triggers, and initiate actions to bring the system back to full operation. In one non-limiting example, the specific triggers detected by the wake-up circuit 246 may correspond to either the TN mode or the NTN mode initiating to switch from the inactive state to the connected state. The wake-up circuit 246 may be able to achieve power efficiency by keeping the controller 220 in a low-power state or the sleep mode until it is needed.

The sleep oscillator 248 may be a low-frequency clock source designed specifically for low-power modes or the sleep mode. The sleep oscillator 248 may be configured to provide a basic timing reference for the controller 220 when operating in sleep or idle modes, allowing the controller 220 to perform minimal tasks (or near minimal tasks) without activating higher-frequency clocks that consume more power. The RT clock 249 may be a clock source that provides an accurate measure of time, often with a battery backup to ensure timekeeping continuity during power interruptions. The RT clock 249 is important for time-sensitive applications, scheduling tasks, and timestamping events. In one embodiment, the RT clock 249 may be configured to maintain an accurate time during the low-power modes or the sleep mode.

The RF transceiver 250 may be designed to connect to both the terrestrial and non-terrestrial networks. The RF transceiver 250 may be configured to handle a broad spectrum of frequency bands, supporting communication protocols for terrestrial networks like LTE or 5G, as well as those required for non-terrestrial networks, such as satellite constellations operating in Low Earth Orbit (LEO), Medium Earth Orbit (MEO), or Geostationary Orbit (GEO). In one exemplary embodiment of the present disclosure, the RF transceiver 250 may incorporate advanced modulation schemes, including Quadrature Phase Shift Keying (QPSK), 16 Quadrature Amplitude Modulation (16 QAM), and higher-order modulation like 8 Phase Shift Keying (8PSK), to adapt to varying link conditions and optimize data rates for both terrestrial and space-based connections. Additionally, the RF transceiver 250 may employ adaptive coding and modulation (ACM) to dynamically adjust parameters based on the quality of the link, ensuring efficient data transmission. The RF transceiver 250 is coupled to the one or more antennas 203 to receive analog signals and coupled to the digital front-end unit 218 to provide the analog signals.

The one or more antennas 203 may be configured to facilitate communication with other ones of UEs 110, the satellites 120, and the ground base stations 145. In one embodiment, the one or more antennas 203 may be coupled with a wireless personal area network (WPAN) radio that is configured to facilitate wireless connectivity with the other ones of the UEs 110. In one example, the WPAN radio may be a Bluetooth Low Energy (BLE) Radio configured to communicate with the other ones of the UEs 110 via Bluetooth. In another embodiment, the one or more antennas 203 may be coupled with an NTN radio that is configured to facilitate wireless connectivity between the UEs 110 and the satellites 120. In yet another embodiment, the one or more antennas 203 may be coupled with a TN radio that is configured to facilitate wireless connectivity between the UEs 110 and the ground base stations 145.

In an embodiment of the present disclosure, the US 110 may include a set of shared resources, such as the one or more antennas 203, the RF transceiver 250, and the flash memory 232. The network modem 210 in the TN mode is further configured to access the set of shared resources to connect with the TN, and the network modem 210 in the NTN mode is further configured to access the set of shared resources to connect with the NTN. The controller 220 may be configured to non-simultaneously grant access of the set of shared resources to the network modem 210 to connect with the TN and the NTN. Thus, the set of shared resources, such as the one or more antennas 203, the RF transceiver 250, and the flash memory 232, that are utilized for both the TN mode and the NTN mode reduces a requirement of a separate resources for each of the TN and NTN modes resulting into efficient utilization of resources and reduction in overall costs.

The one or more sensors 204 may be configured to measure a plurality of physical parameters. The UEs 110 may include at least one battery 206, and solar cells 208 configured to receive light and charge the at least one battery 206.

### Satellites

Each of the satellites 120 may be a communications satellite that includes at least one base station 150. The base station 150 on the satellite 120 is an important component of the satellite communication systems, serving as an access point for two-way data transmission between Earth-based UEs 110 and the satellites 120 as well as between two or more of the satellites 120. The base station 150 may be housed within (or as part of) the satellite's payload and may include transceivers and antennas designed to facilitate seamless communication across vast distances. The base station 150 plays a role in relaying, amplifying, and routing signals between terrestrial devices, such as the UEs 110, and the satellites 120, ensuring robust and efficient data transfer. The base stations 150 are often equipped with advanced signal processing capabilities, enabling functions like modulation, demodulation, encoding, and decoding to optimize the quality and reliability of communication links 115, and can be important for various satellite-based services, including global broadband internet, broadcasting, navigation, internet of things (IoT) services, and Earth observation.

In one implementation, each satellite 120 may be a 5G Non-Terrestrial Network (NTN) satellite, in which case the base station 150 may be referred to as a “gNodeB.” In this context, a gNodeB may refer to a Third Generation Partnership Project (3GPP)-compliant implementation of the 5G base station. The gNodeB includes independent network functions, which implement 3GPP-compliant new radio (NR) radio access network (RAN) protocols namely. One non-limiting example of a base station will now be described with reference to FIG. 1B.

FIG. 1B is a block diagram of an exemplary base station 150 in which aspects of the technology may be employed, where “exemplary” means one non-limiting example. In some embodiments, such as that illustrated, the base station 150 may be equipped with multiple antennas 155.

At the base station 150, a transmit processor 152 may receive data from a data source 151 for one or more UEs 110, select one or more modulation and coding schemes (MCS) for each UE based at least in part on channel quality indicators (CQIs) received from the UE 110, process (e.g., encode and modulate) the data for each UE based at least in part on the MCS(s) selected for the UE 110, and provide data symbols for UEs 110. The transmit processor 152 may further process system information (e.g., for semi-static resource partitioning information (SRPI) and/or the like) and control information (e.g., CQI requests, grants, upper layer signaling, and/or the like) and provide overhead symbols and control symbols. The transmit processor 152 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 153 may perform spatial processing (e.g., precoding) on the data symbols, the control symbols, the overhead symbols, and/or the reference symbols, if applicable, and may provide T output symbol streams to T modulators (MODs) 154A. Each modulator 154A may process a respective output symbol stream (e.g., for OFDM and/or the like) to obtain an output sample stream. Each modulator 154A may further process (e.g., convert to analog, amplify, filter, and upconvert) the output sample stream to obtain a downlink signal. T downlink signals from modulators 154A may be transmitted via the antennas 155. According to various aspects described in more detail below, the synchronization signals may be generated with location encoding to convey additional information.

At UE 110, antennas may receive the downlink signals from base station 150 and/or other base stations and may provide received signals to demodulators (DEMODs) 154B. Each demodulator 154B may condition (e.g., filter, amplify, downconvert, and digitize) a received signal to obtain input samples. Each demodulator 154B may further process the input samples (e.g., for OFDM and/or the like) to obtain received symbols. A MIMO detector 156 may obtain received symbols from the demodulators 154B, perform MIMO detection on the received symbols if applicable, and provide detected symbols. A receive processor 157 may process (e.g., demodulate and decode) the detected symbols, provide decoded data for the UE 110 to a data sink 158, and provide decoded control information and system information to a controller/processor 159. A channel processor may determine reference signal received power (RSRP), received signal strength indicator (RSSI), reference signal received quality (RSRQ), channel quality indicator (CQI), and/or the like.

On the uplink, at UE 110, the UE 110 may receive and process data from a data source (not shown) and control information (e.g., for reports comprising RSRP, RSSI, RSRQ, CQI, and/or the like). The UE 110 may also generate reference symbols for one or more reference signals. The symbols generated may be precoded if applicable, further processed by modulators (not shown) of the UE 110 (e.g., for DFT-s-OFDM, CP-OFDM, and/or the like), and transmitted to base station 150. At base station 150, the uplink signals from UE 110 and other UEs may be received by antennas 155, processed by demodulators 154B, detected by a MIMO detector 156 if applicable, and further processed by a receive processor 157 to obtain decoded data and control information sent by UE 110. The receive processor 157 may provide the decoded data to a data sink 158 and the decoded control information to the controller/processor 159. The base station 150 may include a communication unit 161 and communicate to the UEs 110.

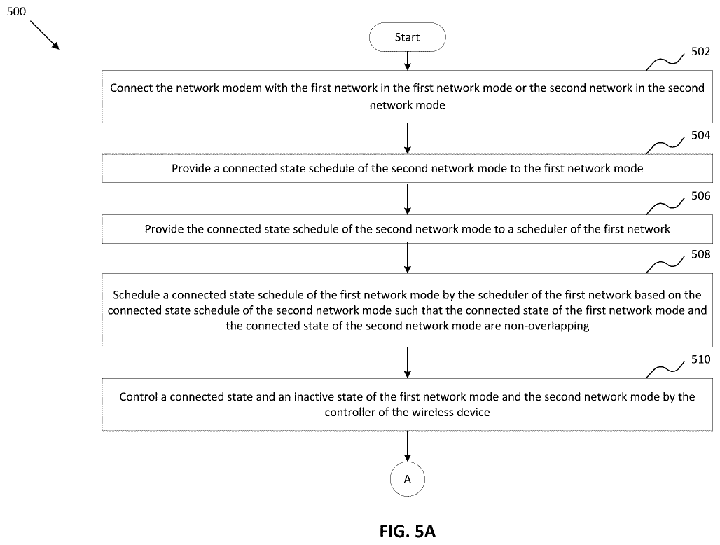

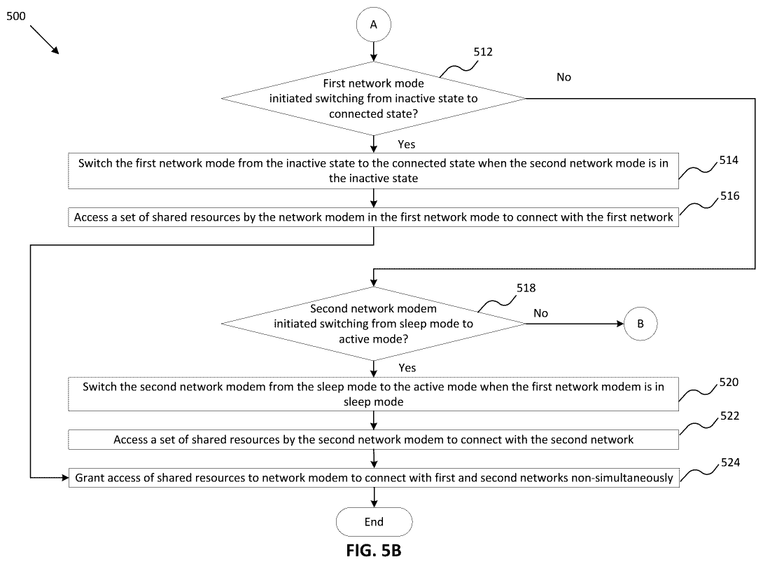

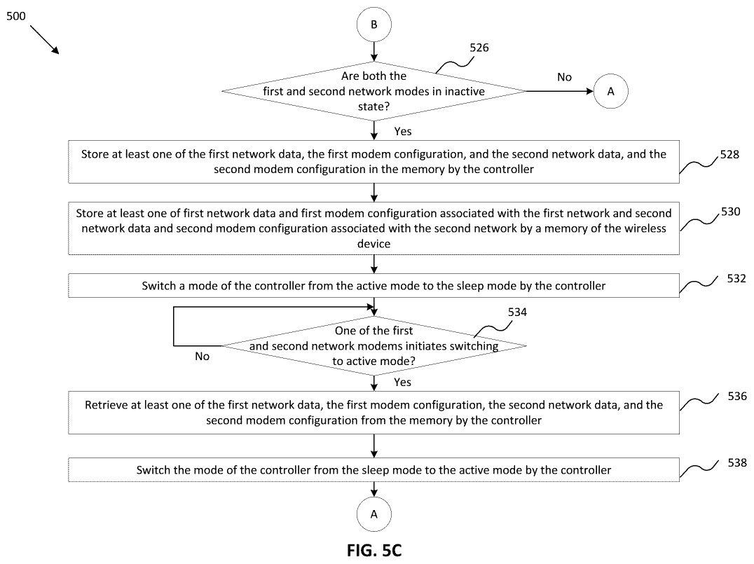

The controller/processor 159 of base station 150 and/or any other component(s) of FIG. 1B may perform one or more techniques associated with random access procedures, as described in more detail elsewhere. For example, the controller/processor 159 of base station 150 and/or any other component(s) of FIG. 2 may perform or direct operations of, for example, the method 500 of FIGS. 5A-5C and/or other processes as described. The memory 160 may store data and program codes for base station 150. For example, the memory 160 may store the RACH timing manager (not shown). A scheduler 162 may schedule UEs for data transmission on the downlink and/or uplink.

In some aspects, the UE 110 may include means for receiving, means for transmitting, means for starting, and means for entering a sleep state, means for skipping one RACH occasion. The base station 150 can include means for receiving, means for transmitting, means for scheduling, and means for grouping. Such means may include one or more components of the UE 110 or base station 150 described in connection with FIG. 1B.

As described above, each base station 150 may include an antenna system that is capable of communicating with UEs 110. In some embodiments, each antenna system may be implemented as an array antenna system. Antenna arrays, including phased array antenna systems, can dynamically adjust their radiation patterns to focus energy in a desired direction, enhancing the chances of non-line-of-sight (NLOS) communication. Phased array antenna systems are known for their adaptability, as they can dynamically adjust their beam patterns without mechanical movement. This flexibility is especially valuable for satellites in NTN configurations, where efficient communication with multiple ground-based stations and user equipment may be important as the satellite orbits the Earth. Additionally, lower-frequency signals tend to diffract and penetrate obstacles more effectively than higher-frequency signals. Further, when the wavelength of the signal is comparable to the size of the obstacle signals can bend or diffract around obstacles.

In some embodiments, each antenna system may be implemented as a phased array antenna system. One non-limiting example of a phased array antenna system will now be described with reference to FIG. 1C, which is a block diagram of an exemplary phased array antenna system in which aspects of the technology may be employed. The phased array antenna system 170 may also be referred to as electronically steerable or scanned array, which may be used in any of the embodiments disclosed herein.

A phased array refers to an array of radiators forming a main beam, wherein the direction of the main beam is electronically steerable by changing the phase/time delay of the RF energy arriving at each of the radiators. For simplicity, the illustration shows a linear array, but for the disclosed embodiments it is more beneficial to utilize a two-dimensional array, such that the beam can be steered in two dimensions. The array comprises radiating elements 175, each connected to a phase shifter 180. Each of the phase shifters 180 may be in the form of a delay line. The phase shifters 180 are controlled by a computer C to introduce a certain amount of delay in the corresponding transmission lines and thereby steer the beam from boresight by an angle θ.

The transmitter TX generates the signal, which is applied to a corporate feed 185, which splits the signal to be delivered to each of the radiating elements 175. Prior to reaching the radiating element, the signal from the feed passes through the corresponding phase shifter 180 such that the phase of the signal in each delay line is changed by an individual amount to cause the beam to steer. The phase shifters 180 can also be controlled by an on-chip processor or baseband processor. The range of each phase shifter can be quantized into a look-up table (LUT). The beam can be steered by quickly retrieving a phase value from the memory. The reverse happens for reception.

The example illustrated in FIG. 1C is a passive phased array or passive electronically scanned array (PESA), which is a phased array in which the antenna elements are connected to a single transmitter and/or receiver. However, the disclosed embodiments are not limited to PESA, but rather encompass any electronically steerable antenna. For example, an active phased array or active electronically scanned array (AESA) may also be used. AESA is a phased array in which each antenna element has an analog transmitter/receiver (T/R) module which creates the phase shifting to electronically steer the antenna beam. Any of the disclosed embodiments may also be implemented using a digital beam forming (DBF) phased array, which has a digital receiver/exciter at each element in the array. The signal at each element is digitized by the receiver/exciter, so that antenna beams can be formed digitally in a field programmable gate array (FPGA) or the array computer. This approach allows for multiple simultaneous antenna beams to be formed, e.g., by grouping the radiating elements into sub-groups.

In general, it should be appreciated that each antenna may be any electronically steerable antenna having plurality of radiators, such as the phased array antenna similar to the example illustrated in FIG. 1C. For simplicity, the disclosure provided herein uses the term “phased array antenna”, but it should be appreciated that the term encompasses any electronically steerable antenna having plurality of radiators forming a radiation pattern the direction of which can be steered electronically.

Referring again to FIG. 1A, when the antenna system of each base station 150 is implemented as a phased array antenna system, each phased array antenna system may dynamically steer beams and provide coverage to different locations as the satellite 120 moves across the sky. Stated differently, each phased array antenna system can dynamically steer and shape the radiation pattern of the antenna, making it an important component for establishing efficient and reliable communication links between satellites 120 and ground-based stations and user devices, such as the UEs 110.

Each phased array antenna system may be capable of both transmitting and receiving signals, and may be designed to provide directional control over the transmitted and received electromagnetic signals. For example, when transmitting, each phased array antenna system may be configured to generate a beam of radio waves. In this context, a beam refers to a focused or directed signal that is transmitted from the satellite's antenna to a specific area on the Earth's surface. The satellite's antenna system is designed to concentrate the signal's energy into a narrow region, effectively creating a “beam” of communication that covers a targeted geographic area. In other words, a beam may refer to the directed path of radio waves that target specific areas on the Earth's surface to provide communication services, where a radio wave can refer to a specific type of electromagnetic wave that carries a communication signal with a particular frequency and wavelength. The radio wave includes both the carrier frequency and the modulated information, such as voice, data, or video.

Each phased array antenna system adjusts the phase and amplitude of individual antenna elements to create a focused and directed beam of electromagnetic waves. By carefully controlling the phase relationships of the signals emitted from each element, the antenna can steer the beam's direction without physically moving the entire antenna structure. This directed beam allows the satellite to target specific areas on the Earth's surface for communication.

By contrast, when the phased array antenna system is in receiving mode, it utilizes the same principles of phase and amplitude control to selectively receive signals from a particular direction. The received signals are then combined coherently to enhance the sensitivity of the antenna in that specific direction. This directional receiving capability is useful for efficiently capturing signals from the desired sources while reducing or minimizing interference from other directions.

Each base station 150 may be configured to transmit information to one or more UEs 110 and receive the PRACH signal from at least one of the UEs 110 processible by the base station (e.g., the network node) of the satellite 120 to establish a connection between the UE 110 and the satellite 120. In an exemplary embodiment of the present disclosure, each antenna 203 of each of the UEs 110 is configured to communicate directly with at least one phased array antenna system of at least one of the plurality of satellites 120.

In an exemplary embodiment of the present disclosure, as illustrated in FIG. 1A, the UEs 110 are configured to communicate with each other and exchange data when in range of each other. This allows for the UEs 110 to be configured as a mesh network so that the UEs 110 can communicate information with each other. Similarly, as illustrated in FIG. 1A, the satellites 120 are configured to communicate with each other and exchange data when in range of each other. This allows for the satellites 120 to be configured as a mesh network so that the satellites 110 can communicate information with each other via intersatellite links.

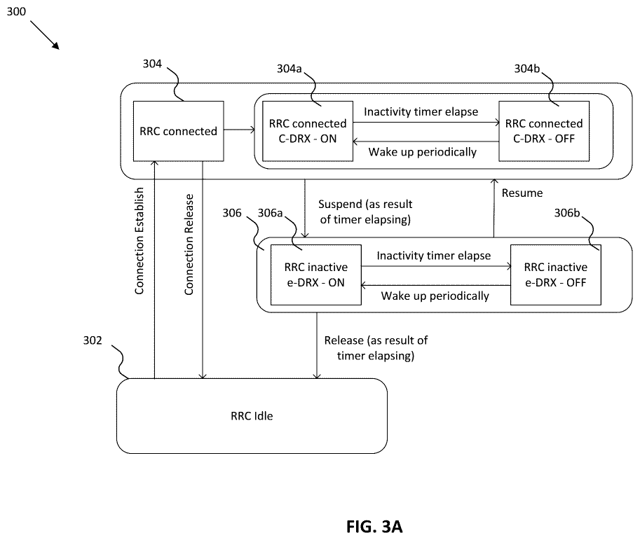

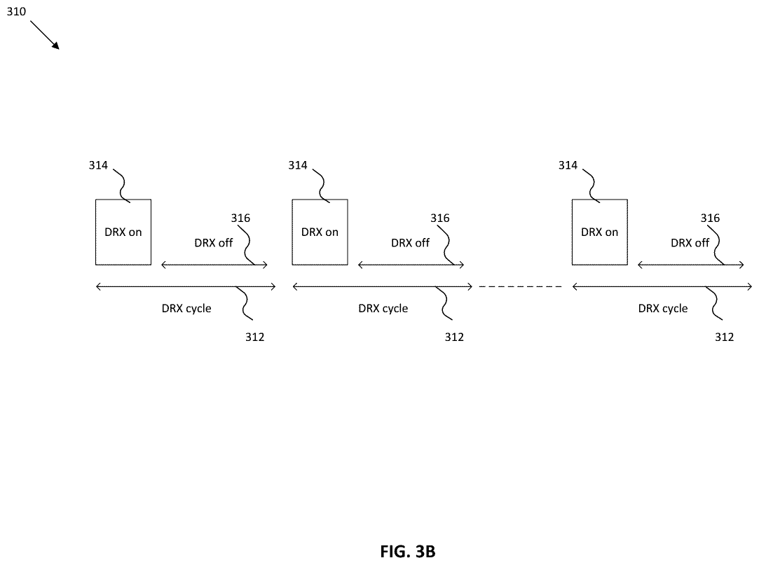

FIG. 3A is a block diagram 300 illustrating one example of a state transfer procedure of the UE 110 according to aspects of the disclosed technology. FIG. 3B is a timing diagram 310 illustrating one example of a duration of a state transfer procedure of the UE 110 according to aspects of the disclosed technology. Referring now to FIG. 3A, in one embodiment of the present disclosure, the UE 110 may be in one of the three radio resource control (RRC) states, namely, RRC idle state 302, RRC connected state 304, and RRC inactive state 306 for a 5^{th} Generation (5G) New Radio (NR).

After power up, the UE 110 may be in the RRC idle state 302. In order to perform data transfer, the UE 110 may need to establish connection with the network which is done using initial access via RRC connection establishment procedure. Once RRC connection is established, the UE 110 is in the RRC connected state 304. The network initiates an RRC connection release procedure to transit the UE 110 from the RRC connected state 304 to the RRC idle state 302.

When the UE 110 is in the RRC connected state, Connected Mode Discontinuous Reception (C-DRX) is a power-saving feature implemented in the RRC connected state 304 to optimize the energy consumption of the UE 110 during periods of inactivity. C-DRX allows the UE 110 to periodically enter a sleep mode, where it deactivates its radio receiver for defined intervals, thus conserving power while still maintaining synchronization with the serving cell. The primary goal is to reduce unnecessary power consumption when there is no ongoing data exchange or communication activity.

Referring now to FIG. 3B, parameters of a Discontinuous Reception (DRX) cycle 312 are configured by the network and provided to the UE 110. The parameters of the DRX cycle include a DRX on duration 314 (active time when the radio receiver is turned on) and an DRX off-duration 316, i.e., DRX inactivity timer (time period during which the radio receiver can be turned off).

Referring now to FIGS. 3A and 3B, during periods of activity, the UE 110 is in an RRC connected C-DRX on state 304a. During periods of inactivity, the UE 110 monitors the configured DRX cycle 312 and transitions to an RRC connected C-DRX off state 304b, which is a low-power state, by deactivating the radio receiver. In one embodiment of the present disclosure, the UE 110 transitions to the low power state when an inactivity timer elapses which helps to save power when there are no active data transmissions or when the UE 110 is waiting for potential incoming data. Further, to accommodate potential data arrivals during DRX off duration 316, the network sends signaling (e.g., paging) to inform the UE 110 about incoming data or the need to re-establish communication. The UE 110 periodically wakes up and activates the radio receiver when required thus transitioning into the RRC connected C-DRX on state 304a.

Further, the UE 110 is in the RRC connected state 304 when an RRC connection has been established or in the RRC inactive state 306 when the RRC connection is suspended. The RRC inactive state 306 is used to reduce network signaling load as well as to reduce latency involved in transitioning to the RRC connected state 304. Moreover, the UE 110 in the RRC inactive state 306 may be allowed to behave in a similar way as in the RRC idle state 302 to save power. In the RRC inactive state 306, Access Stratum (AS) context is stored by both the UE 110 and g-Node B (gNB), as a result of which the state transition from the RRC inactive state 306 to the RRC connected state 304 is faster. In the RRC inactive state 306, the UE 110 may not transmit anything in the uplink except for PRACH as part of random access procedure initiated when the UE 110 desires to transit to the RRC connected state 304 to request for on-demand system information.

Extended Discontinuous Reception (e-DRX) is an enhanced power-saving feature implemented in the RRC inactive state 306. Similar to the traditional DRX and C-DRX, e-DRX aims to reduce the power consumption of the UE 110 during periods of inactivity. However, e-DRX introduces further improvements by allowing the UE 110 to stay in an even more extended sleep mode, leading to greater power savings. During periods of activity, the UE 110 is in an RRC inactive e-DRX on state 306a. During periods of inactivity, the UE 110 monitors the configured DRX cycle and transitions to an RRC inactive e-DRX off state 306b, which is a low-power state, by deactivating the radio receiver. In one embodiment of the present disclosure, the UE 110 transitions to the low power state for prolonged sleep durations when an inactivity timer elapses which helps to save power. Similar to C-DRX, the network sends signaling (e.g., paging) to inform the UE 110 about incoming data or the need to re-establish communication. The UE 110 periodically wakes up and activates the radio receiver when required thus transitioning into the RRC inactive e-DRX on state 306a.

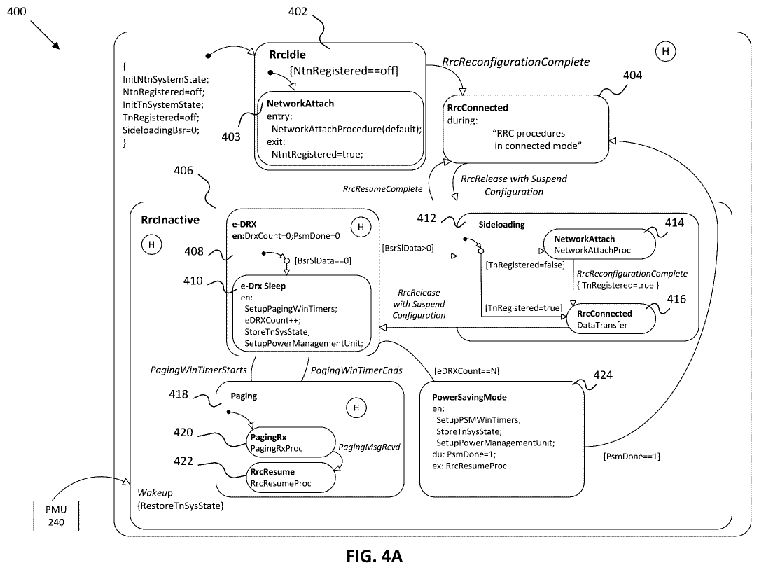

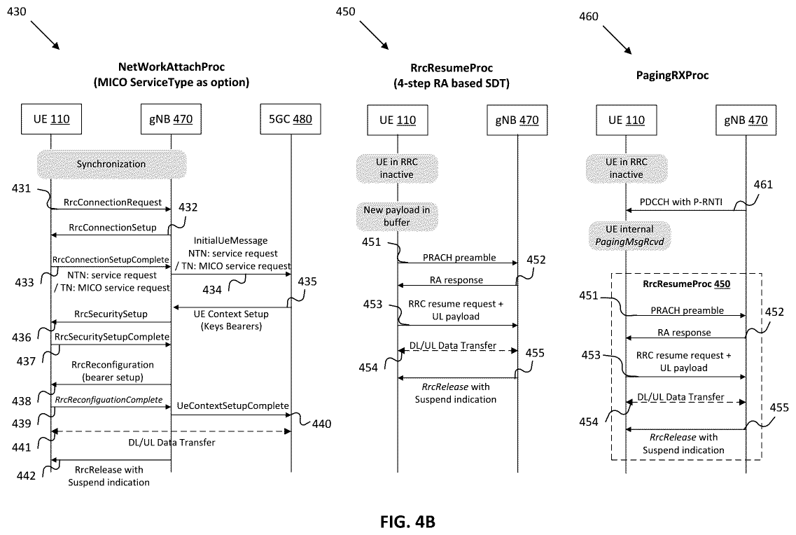

FIG. 4A is another block diagram 400 illustrating another example of the state transfer procedure of the UE 110 according to aspects of the disclosed technology. In one embodiment of the present disclosure, the state transfer procedure of the UE 110 is configured and executed by the MCU core 222 of the controller 220. Initially, the controller 220 may initialize NTN system state as NTN connection is not registered (NtnRegistered=off) and initialize TN system state as TN connection is not registered (TnRegistered=off) and no sideloading data available (SideloadingBsr=0). The UE 110 may be in one of the three RRC states, namely, RRC Idle state 402, RRC connected state 404, and RRC inactive state 406 for 5G NR.

After power up, the UE 110 may be in the RRC idle state 302. In order to perform data transfer, the UE 110 may need to establish connection with the network which is done using initial access via RRC connection establishment procedure. In some aspects of the present disclosure, to establish connection with the NTN network, the controller 220 transitions the UE 110 to NetworkAttach State 403 for NTN. In the NetworkAttach State 403, the UE 110 may execute a network attach procedure to register the NTN connection (NtnRegistered=true). The network attach procedure may be explained in detail in FIG. 4B. Once RRC connection is established, i.e., the RRC reconfiguration is complete, the UE 110 is in the RRC connected state 404 for NTN. During the RRC connected state 404, the RRC procedures are performed by the UE 110 in the connected modes. For example, the UE 110 (e.g., the UE 110A) may connect with the satellite 120 (e.g., the satellite 120A) for data transfer procedures, i.e., to send or receive data. The NTN may initiate an RRC release procedure with suspend configuration to transit the UE 110 from the RRC connected state 404 to the RRC inactive state 406 for NTN.

While in the RRC inactive state 406, the UE 110 may be in an e-DRX state 408. During the e-DRX state 408, the controller 220 of the UE 110 may be configured to initialize a DRX count value (DrxCount=0) to indicate the number of times the UE 110 transitioned to an e-DRX Sleep state 410 and initialize a power saving mode indicator (PsmDone=0) to indicate whether the UE 110 has transitioned to power saving mode 424 and completed the power saving mode duration. In some embodiments, the controller 220 monitors whether there is sideloading data available. If the controller 220 identifies that the sideloading data is unavailable (BrsSIData==0), the UE 110 further transitions to e-DRX Sleep state 410. During the e-DRX Sleep state 410, the controller 220 of the UE 110 may set up paging timers (SetupPagingWinTimers), increment the DRX count value (DrxCount++) to indicate that the UE 110 transitioned to the e-DRX Sleep state 410, store the TN system state in the Flash memory 232, and set up the power management unit 240. If the controller 220 identifies that the sideloading data is available (BrsSIData>0), the UE 110 further transitions to sideloading state 412.

During the sideloading state 412, the controller 220 may monitor the TN system state whether the TN connection is registered or not registered. If the controller 220 determines that the TN connection is not registered (TnRegistered=False), the UE 110 may need to establish connection with the TN network in order to perform data transfer. In some aspects of the present disclosure, to establish connection with the TN network, the controller 220 transitions the UE 110 to NetworkAttach state 414 for TN. In the NetworkAttach State 414, the UE 110 may execute a network attach procedure to register the TN connection (TnRegistered=true). The network attach procedure may be explained in detail in FIG. 4B. Once RRC connection is established, i.e., the RRC reconfiguration is complete, the UE 110 is in the RRC connected state 416 for TN. Further, if the controller 220 determines that the TN connection is registered (TnRegistered=True), the UE directly transitions to the RRC connected state 416 for TN without transitioning to the NetworkAttach state 414 for TN. During the RRC connected state 416 for TN, the RRC procedures are performed by the UE 110 in the connected modes. For example, the UE 110 (e.g., the UE 110A) may connect with the ground base station 145 (e.g., the ground base station 145A) for data transfer procedures, i.e., to send or receive data. The TN may initiate an RRC release procedure with suspend configuration to transit the UE 110 from the RRC connected state 416 for TN to the RRC inactive state for TN, thereby the UE 110 may return to the e-DRX state 408.

In some embodiments, the UE 110 may periodically perform a paging procedure during a paging state 418 to determine whether there is an availability to establish connection with the NTN network. When the paging timers set up by the controller 220 starts, the UE 110 transitions to a PagingRx state 420 and performs the paging procedure. During the paging procedure, if the UE 110 receives a paging message (PagingMsgRcvd), the UE 110 transitions to a RrcResume state 422 and performs an RRC resume procedure. During the paging procedure, if the UE 110 does not receive the paging message and the paging timers lapse or end, the UE 110 transitions back to the e-DRX state 408. The paging procedure and the RRC resume procedure are explained in detail in FIG. 4B.

In some embodiments, during the e-DRX state 408, if the controller 220 determines that the DRX count value is equal to a predefined threshold value (eDRXCount=N) and both the TN mode and the NTN mode are in the inactive state, the UE 110 (i.e., the controller 220) transitions to the power saving mode 424 or the sleep mode. While in the power saving mode 424, the controller 220 may set up power saving mode timers, store the TN system state in the Flash memory 232, and set up the power management unit 240. In an exemplary embodiment of the present disclosure, in the power saving mode 424, the controller 220 may further store the NTN system state. During the power saving mode 424, the controller 220 may monitor the power saving mode timers. Once the power saving mode timers elapse, the controller 220 may modify the power saving mode indicator (PsmDone=1) to indicate that the UE 110 has completed the power saving mode duration. When the UE 110 wakes up from the power saving mode, the PMU 240 may provide the state retention data and the UE 110 may restore the TN system state. In some examples, the UE 110 may restore the TN system state by retrieving the TN system state from the Flash memory 232. Upon completion of the power saving mode duration, the UE 110 may perform the RRC resume procedure for NTN and transition to the RRC connected state 404 for NTN.

In an exemplary embodiment of the present disclosure, the UE 110 may further restore the NTN system state by retrieving the NTN system state from the Flash memory 232. The NTN system state may include the second modem configuration for NTN and the NTN data. Similarly, the TN system state may include the first modem configuration for TN and the TN data.

FIG. 4B is a process flow diagram illustrating one example of process flow during the state transfer procedure of the UE according to aspects of the disclosed technology. The process flow diagram includes a process flow 430 for the network attach procedure (NetWorkAttachProc), a process flow 450 for the RRC resume procedure (RrcResumeProc), and a process flow 460 for the paging procedure (PagingRXProc).

Referring now to the process flow 430 for the network attach procedure between the UE 110, a gNB 470, and a 5G core network (5GC) 480. In one embodiment of the present disclosure, the gNB 470 may correspond to the base station 150 of the satellite 120 for the NTN network or may correspond to the ground base station 145 for the TN network.

Initially, synchronization process is performed between the UE 110 and the gNB 470. At 431, the UE 110 may send an RRC connection request message to the gNB 470 to request the network for the establishment of an RRC connection. The RRC connection request may be sent as part of the Random-Access procedure and may be transferred using Signaling Radio Bearer (SRB0) on the Common Control Channel (CCCH) because neither SRB1 nor a Dedicated Control Channel (DCCH) has been setup at this point. At 432, the UE 110 may receive an RRC connection setup message from the gNB 470. The RRC connection setup message may be used to establish SRB1 and may contain configuration information for SRB1 allowing subsequent signaling to use the DCCH logical channel. The configuration for SRB1 may be a specific configuration or the default configuration. Based on the configuration received, the UE 110 may set up the configuration to establish a connection with the network.

At 433, upon completion of the setup, the UE 110 may send an RRC connection setup complete message to the gNB 470 to confirm the successful completion of an RRC connection establishment. For connection with the NTN network, the RRC connection setup message may include a service request and for connection with the TN network, the RRC connection setup message may include a mobile initiated connection only (MICO) service request. MICO is a mode of operation for 5G devices. When the UE 110 is activated with MICO service type for connection with the TN, the UE 110 is in an Idle state and the TN may consider the UE 110 to be unreachable. The UE 110 may receive data when the UE 110 transitions to a connected state for the TN (i.e., the RRC connected state 416 for TN). The transition to the connected state for TN while the UE 110 is in MICO mode is triggered by the UE 110. The UE 110 may not be paged while in MICO mode.

At 434, the gNB 470 may send an initial UE message to the 5GC 480 along with the service request for NTN or the MICO service request for TN. At 435, the gNB 470 receives a UE context setup request from the 5GC 480 to establish the UE Context including, among others, key bearers like signaling radio bearer (SRB) and data radio bearer (DRB). Upon successful setup of the UE context, at 436, the gNB 470 sends an RRC security setup message to the UE 110 to secure the RRC connection setup procedure so that sensitive information can be shared between genuine network elements. In some embodiment, the gNB 470 may perform identification of the UE 110. Once the UE 110 is successfully identified, at 437, the UE 110 may send a RRC security setup complete message to the gNB 470.

At 438, the UE 110 may receive an RRC reconfiguration request from the gNB 470 to modify an RRC connection. The purpose of the RRC reconfiguration request procedure may be to establish/modify/release Radio Bearer, perform Handover, setup/modify/release measurements, to add/modify/release secondary cells, and transfer dedicated non access stratum (NAS) Information. Upon modification of the RRC connection, at 439, the UE 110 may send an RRC reconfiguration complete message to the gNB 470.

At 440, the gNB 470 may send a UE context setup complete message to the 5GC 480 to indicate that the UE context is successfully setup. Thus, at 441, the connection between the UE 110 and the 5GC 480 is established and data transfer operations are executed. The UE 110 may send data to the 5GC 480 via UL and the 5GC 480 may send data to the UE 110 via DL. At 442, the gNB 470 may send an RRC release message with suspend configuration to the UE 110 and the UE 110 may transition to the RRC inactive state from the RRC connected state.

Referring now to the process flow 450 for the RRC resume procedure between the UE 110 and the gNB 470. Initially the UE 110 is in the RRC inactive state and there is a new payload in the buffer, such as the packet buffers 212. At 451, the UE 110 may send a PRACH preamble to the gNB 470 to establish a connection with the network. Upon receiving the PRACH preamble, the gNB 470 may send an acknowledgement (RA response) to the UE 110 to indicate that connection access has been granted.

At 453, the UE 110 may send an RRC resume request to the gNB 470 to resume the data transfer and along with the RRC resume request may send an UL payload. At 454, the connection between the UE 110 and the gNB 470 is established and data transfer operations are executed. The UE 110 may send data to the gNB 470 via UL and the gNB 470 may send data to the UE 110 via DL. At 455, the gNB 470 may send an RRC release message with suspend indication to the UE 110 and the UE 110 may transition to the RRC inactive state from the RRC connected state.

Referring now to the process flow 460 for the paging procedure between the UE 110 and the gNB 470. Initially the UE 110 is in the RRC inactive state. At 461, the gNB 470 may send physical downlink control channel (PDCCH) information and paging radio network temporary identifier (P-RNTI) to the UE 110. When the UE 110 receives the paging message, the UE 110 executes the RRC resume procedure as shown in the process flow 460 and described above.

FIGS. 5A-5C, collectively, represent a flow chart 500 illustrating one example of a method of operating the UE 110 according to aspects of the disclosed technology. With respect to FIGS. 5A-5C, the steps of each method shown are not necessarily limiting. Steps can be added, omitted, and/or performed simultaneously without departing from the scope of the appended claims. Each method may include any number of additional or alternative tasks, and the tasks shown need not be performed in the illustrated order. Each method may be incorporated into a more comprehensive procedure or process having additional functionality not described in detail herein. Moreover, one or more of the tasks shown could potentially be omitted from an embodiment of each method as long as the intended overall functionality remains intact. Further, each method is computer-implemented in that various tasks or steps that are performed in connection with each method may be performed by software, hardware, firmware, or any combination thereof. For illustrative purposes, the following description of each method may refer to elements mentioned above in connection with FIGS. 1-4B. In certain embodiments, some or all steps of this process, and/or substantially equivalent steps, are performed by execution of processor-readable instructions stored or included on a processor-readable medium. For instance, in the description of FIGS. 5A-5C that follows, the UE(s), base stations, satellites, ground base stations, etc. may be described as performing various acts, tasks or steps, but it should be appreciated that this refers to processing system(s) of these entities executing instructions to perform those various acts, tasks or steps. Depending on the implementation, some of the processing system(s) can be centrally located, or distributed among a number of server systems that work together. Furthermore, in the description of FIGS. 5A-5C, a particular example is described in which a UE performs certain actions by interacting with other elements of the system 100.

Referring now to FIG. 5A, at 502, the controller 220 of the UE 110 may connect the network modem 210 with the first network (TN) in the first network mode (TN mode) or the second network (NTN) in the second network mode (NTN mode). The UE 110 is a wireless device that is capable of dual mode communication, that is, the UE 110 may connect with the terrestrial network or the non-terrestrial network for communication and data transfer and the controller 220 acts as a joint controller for both the modes of communication.

At 504, the controller 220 may provide the connected state schedule of the second network mode to the first network mode. At 506, the first network mode (i.e., the network modem 210) may provide the active mode schedule of the second network mode to the scheduler of the first network. At 508, the scheduler of the first network may schedule the connected state schedule of the first network mode based on the connected state schedule of the second network mode such that the connected state of the first network mode and the connected state of the second network mode are non-overlapping. In one embodiment of the present disclosure, the network modem 210 may connect to the NTN in the NTN mode periodically, the schedule of which may be shared with the TN scheduler to avoid simultaneous connection of the network modem 210 to the TN mode and the NTN mode.

At 510, the controller 220 may control the connected state and the inactive state of the first network mode and the second network mode. The controller 220 may control the transitioning of the UE 110 through various states as described in FIG. 4A. Referring now to FIG. 5B, at 512, the controller 220 may determine whether the first network mode has initiated switching from the inactive state to the connected state. In one embodiment of the present disclosure, when the sideloading data is available, the controller 220 may transition the UE 110 to the sideloading state 412 to establish connection with the TN and perform data transfer operation. If at 512, the controller 220 determines that the first network mode has initiated switching from the inactive state to the connected state, 514 is executed.

At 514, the controller 220 switches the first network mode from the inactive state to the connected state when the second network mode is in the inactive state. At 516, the network modem 210 in the first network mode may access the set of shared resources to connect with the first network. To perform the data transfer operation, the UE 110 may switch to the RRC connected state 416 in TN and utilize the set of shared resources such as the Flash memory 232 to restore the TN system state, and the network modem 210, the RF transceiver 250, and the antenna 203 to connect with the TN network and transfer data. If at 512, the controller 220 determines that the first network mode hasn't initiated switching from the inactive state to the connected state, 518 is executed.

At 518, the controller 220 may determine whether the second network mode has initiated switching from the inactive state to the connected state. In some embodiments, when the UE 110 performs the paging procedure and there is an opportunity available for the UE 110 to connect with the NTN, the UE may initiate the RRC resume procedure. If at 518, the controller 220 determines that the second network mode has initiated switching from the inactive state to the connected state, 520 is executed.

At 520, the controller 220 switches the second network mode from the inactive state to the connected state when the first network mode is in the inactive state. At 522, the network modem 210 in the second network mode may access the set of shared resources to connect with the first network. To perform the data transfer operation, the UE 110 may switch to the RRC connected state 404 in NTN and utilize the set of shared resources such as the Flash memory 232 to restore the NTN system state, and the network modem 210, the RF transceiver 250, and the antenna 203 to connect with the NTN network and transfer data. If at 518, the controller 220 determines that the second network mode hasn't initiated switching from the inactive state to the connected state, 526 is executed.

At 526, the controller 220 may determine whether both the first and second network modes are in the inactive state. If at 526, the controller 220 determines that both the first and second network modes are not in the inactive state, 512 is executed again. In some embodiments, the controller 220 monitors the states of the TN mode and the NTN mode. If at 526, the controller 220 determines that both the first and second network modes are in the inactive state, 528 is executed.

At 528, the controller 220 may store at least one of the first network data, the first modem configuration, and the second network data, and the second modem configuration in the memory, i.e., the Flash memory 232. At 530, the memory may store at least one of first network data and first modem configuration associated with the first network and second network data and second modem configuration associated with the second network. Once the controller 220 has stored the data associated with the TN mode and the NTN mode the controller 220 may enter power saving mode to save power.

At 532, the controller 220 may switch a mode of the controller 220 from the active mode to the sleep mode. While the controller 220 is in the sleep mode or the power saving mode, some components of the power management unit 240 are always on and monitoring for any data transfer initiations. At 534, the controller 220 may determine whether one of the first and second network modes has initiated switching to connected state. If at 534, the controller 220 determines that one of the first and second network modes hasn't initiated switching to connected state, 534 is executed again. If at 534, the controller 220 determines that one of the first and second network modes has initiated switching to connected state, 536 is executed.

At 536, the controller 220 may retrieve at least one of the first network data, the first modem configuration, the second network data, and the second modem configuration from the memory. At 538, the controller 220 may switch the mode of the controller 220 from the sleep mode to the active mode. After 538, 512 is executed again. After 516 and 522, 524 is executed. As and when the network modem 210 may connect to the TN in the TN mode or the NTN in the NTN mode, the controller 220 may control and manage the modem configurations, network data, and access controls to the set of shared resources. At 524, the controller 220 may grant access of the set of shared resources to the network modem 210 to connect with the first network and the second network non-simultaneously.

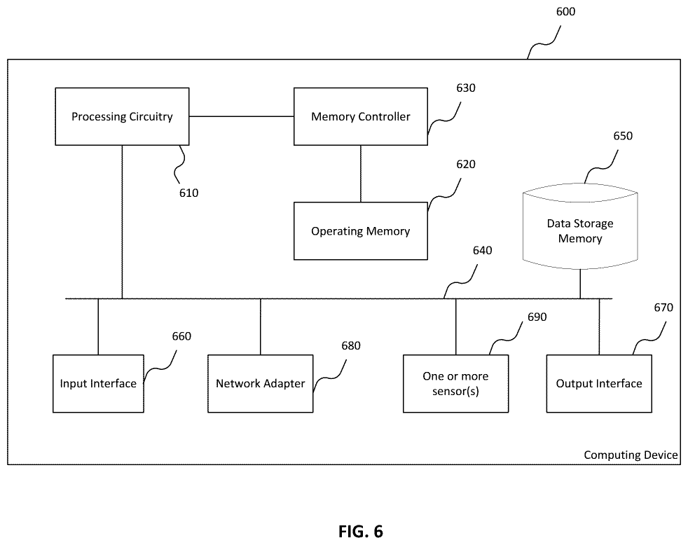

FIG. 6 is a diagram illustrating one example of computing device 600 in which aspects of the technology may be practiced. Computing device 600 may be virtually any type of general-purpose or specific-purpose computing device. For example, computing device 600 may be an example of the controller 220 or a processor of the satellite 120, a computing system or device associated with any entity (e.g., UE 110, satellite 120) as described above with reference to FIGS. 1-5.

As illustrated in FIG. 6, computing device 600 includes processing circuit 610, operating memory 620, memory controller 630, data storage memory 650, input interface 660, output interface 670, one or more network adapter(s) 680, and in some embodiments, one or more sensor(s) 690. Each of these afore-listed components of computing device 600 includes at least one hardware element.

Computing device 600 includes at least one processing circuit 610 configured to execute instructions, such as instructions for implementing the herein-described workloads, processes, or technology. Processing circuit 610 may include a microprocessor, a microcontroller, a graphics processor, a coprocessor, a field-programmable gate array, a programmable logic device, a signal processor, or any other circuit suitable for processing data. The aforementioned instructions, along with other data (e.g., datasets, metadata, operating system instructions, etc.), may be stored in operating memory 620 during run-time of computing device 600. Operating memory 620 may also include any of a variety of data storage devices/components, such as volatile memories, semi-volatile memories, random access memories, static memories, caches, buffers, or other media used to store run-time information. In one example, operating memory 620 does not retain information when computing device 600 is powered off. Rather, computing device 600 may be configured to transfer instructions from a non-volatile data storage component (e.g., data storage memory 650) to operating memory 620 as part of a booting or other loading process. In some examples, other forms of execution may be employed, such as execution directly from data storage memory 650.

Operating memory 620 may include 4th generation double data rate (DDR4) memory, 3rd generation double data rate (DDR3) memory, other dynamic random access memory (DRAM), High Bandwidth Memory (HBM), Hybrid Memory Cube memory, 3D-staked memory, static random access memory (SRAM), magneto resistive random access memory (MRAM), pseudorandom random access memory (PSRAM), or other memory, and such memory may comprise one or more memory circuits integrated onto a DIMM, SIMM, SODIMM, Known Good Die (KGD), or other packaging. Such operating memory modules or devices may be organized according to channels, ranks, and banks. For example, operating memory devices may be coupled to processing circuit 610 via memory controller 630 in channels. One example of computing device 600 may include one or two DIMMs per channel, with one or two ranks per channel. Operating memory within a rank may operate with a shared clock, and shared address and command bus. Also, an operating memory device may be organized into several banks where a bank can be thought of as an array addressed by row and column. Based on such an organization of operating memory, physical addresses within the operating memory may be referred to by a tuple of channel, rank, bank, row, and column.

Despite the above discussion, operating memory 620 specifically does not include or encompass communications media, any communications medium, or any signals per se.

Memory controller 630 is configured to interface processing circuit 610 to operating memory 620. For example, memory controller 630 may be configured to interface commands, addresses, and data between operating memory 620 and processing circuit 610. Memory controller 630 may also be configured to abstract or otherwise manage certain aspects of memory management from or for processing circuit 610. Although memory controller 630 is illustrated as single memory controller separate from processing circuit 610, in other examples, multiple memory controllers may be employed, memory controller(s) may be integrated with operating memory 620, or the like. Further, memory controller(s) may be integrated into processing circuit 610. These and other variations are possible.

In computing device 600, data storage memory 650, input interface 660, output interface 670, network adapters 680, and sensors 690 may be interfaced to processing circuit 610 by bus 640. Although, FIG. 6 illustrates bus 640 as a single passive bus, other configurations, such as a collection of buses, a collection of point-to-point links, an input/output controller, a bridge, other interface circuitry, or any collection thereof may also be suitably employed for interfacing data storage memory 650, input interface 660, output interface 670, or network adapters 680 to processing circuit 610.

In computing device 600, data storage memory 650 is employed for long-term non-volatile data storage. Data storage memory 650 may include any of a variety of non-volatile data storage devices/components, such as non-volatile memories, disks, disk drives, hard drives, solid-state drives, or any other media that can be used for the non-volatile storage of information. However, data storage memory 650 specifically does not include or encompass communications media, any communications medium, or any signals per se. In contrast to operating memory 620, data storage memory 650 is employed by computing device 600 for non-volatile long-term data storage, instead of for run-time data storage.

Also, computing device 600 may include or be coupled to any type of processor-readable media such as processor-readable storage media (e.g., operating memory 620 and data storage memory 650) and communication media (e.g., communication signals and radio waves). While the term processor-readable storage media includes operating memory 620 and data storage memory 650, the term “processor-readable storage media,” throughout the specification and the claims whether used in the singular or the plural, is defined herein so that the term “processor-readable storage media” specifically excludes and does not encompass communications media, any communications medium, or any signals per se. However, the term “processor-readable storage media” does encompass processor cache, Random Access Memory (RAM), register memory, and/or the like.

Computing device 600 also includes input interface 660, which may be configured to enable computing device 600 to receive input from users or from other devices, such as sensors 690, in some embodiments. In addition, computing device 600 includes output interface 670, which may be configured to provide output from computing device 600.

In the illustrated example, computing device 600 is configured to communicate with other computing devices or entities via network adapters 680. Network adapters 680 may include a wired network adapter, e.g., an Ethernet adapter, a Token Ring adapter, or a Digital Subscriber Line (DSL) adapter. Network adapters 680 may also include a wireless network adapter, for example, a Wi-Fi adapter, a Bluetooth adapter, a ZigBee adapter, a Long-Term Evolution (LTE) adapter, SigFox, LoRa, Powerline, or a 5G adapter.

Although computing device 600 is illustrated with certain components configured in a particular arrangement, these components and arrangement are merely one example of a computing device in which the technology may be employed. In other examples, data storage memory 650, input interface 660, output interface 670, or network adapters 680 may be directly coupled to processing circuit 610, or be coupled to processing circuit 610 via an input/output controller, a bridge, or other interface circuitry. Other variations of the technology are possible.

Some examples of computing device 600 include at least one memory (e.g., operating memory 620) adapted to store run-time data and at least one processor (e.g., processing circuit 610) that is adapted to execute processor-executable code that, in response to execution, enables computing device 600 to perform actions, where the actions may include, in some examples, actions for one or more methodologies or processes described herein, such as, method 500 of FIGS. 5A-5C, as described above.

In some embodiments, when the device or system include one or more sensors 690, the sensors may be configured to sense or gather data pertaining to the surrounding environment or operation of the device or system. Some exemplary sensors capable of being electronically coupled with the device or system of the present disclosure (either directly connected to the device or system of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; Global Positioning sensors sensing location, elevation, distance traveled, velocity/speed; audio sensors sensing local environmental sound levels, or voice detection; photo/Light sensors sensing ambient light intensity, ambient, day/night, UV exposure; TV/IR sensors sensing light wavelength; temperature sensors sensing machine or motor temperature, ambient air temperature, and environmental temperature; and moisture sensors for sensing surrounding moisture levels.

The device or system of the present disclosure may include wireless communication logic coupled to sensors on the device or system. The sensors gather data and provide the data to the wireless communication logic. Then, the wireless communication logic may transmit the data gathered from the sensors to a remote device. Thus, the wireless communication logic may be part of a broader communication system, in which one or several devices or systems of the present disclosure may be networked together to report alerts and, more generally, to be accessed and controlled remotely. Depending on the types of transceivers installed in the device or system of the present disclosure, the system may use a variety of protocols (e.g., Wifi, ZigBee, MiWi, Bluetooth) for communication. In one example, each of the devices or systems of the present disclosure may have its own IP address and may communicate directly with a router or gateway. This would typically be the case if the communication protocol is WiFi.

In another example, a point-to-point communication protocol like MiWi or ZigBee is used. One or more of the device or system of the present disclosure may serve as a repeater, or the devices or systems of the present disclosure may be connected together in a mesh network to relay signals from one device or system to the next. However, the individual device or system in this scheme typically would not have IP addresses of their own. Instead, one or more of the devices or system of the present disclosure communicates with a repeater that does have an IP address, or another type of address, identifier, or credential that may be needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system also allows individuals to access the device or system of the present disclosure for configuration and diagnostic purposes. In that case, the individual processors or microcontrollers of the device or system of the present disclosure may be configured to act as Web servers that use a protocol like hypertext transfer protocol (HTTP) to provide an online interface that can be used to configure the device or system. In some embodiments, the systems may be used to configure several devices or systems of the present disclosure at once. For example, if several devices or systems are of the same model and are in similar locations in the same location, it may not be to configure the devices or systems individually. Instead, an individual may provide configuration information, including baseline operational parameters, for several devices or systems at once.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software-controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an example embodiment,” “an exemplary embodiment,” or “other embodiments,” or the like, means that a particular feature, structure, or characteristic described in connection with the embodiments is included in at least some embodiments, but not necessarily all embodiments, of the disclosure. The various appearances “an embodiment,” “one embodiment,” “some embodiments,” “one particular embodiment,” “an example embodiment,” “an exemplary embodiment,” or “other embodiments,” or the like, are not necessarily all referring to the same embodiments. References in the specification to “an embodiment,” “one embodiment,” “some embodiments,” “one particular embodiment,” “an example embodiment,” “an exemplary embodiment,” or “other embodiments,” or the like, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. As used herein in the specification and claims, including as used in the examples and unless otherwise expressly specified, numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

The description and illustration of various embodiments of the disclosure are examples and the disclosure is not limited to the exact details shown or described. While various embodiments of the disclosed subject matter have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

What is claimed:

1. A wireless device, comprising:
a network modem configured to connect with a first network in a first network mode and connect with a second network in a second network mode; and
a controller configured to:
control a connected state and an inactive state of the first network mode and the second network mode;
switch the first network mode from the inactive state to the connected state when the second network mode is in the inactive state; and
switch the second network mode from the inactive state to the connected state when the first network mode is in the inactive state.

2. The wireless device of claim 1, wherein the first network is a terrestrial network, and the second network is a non-terrestrial network.

3. The wireless device of claim 1, wherein the wireless device is a user equipment.

4. The wireless device of claim 1, wherein the first network mode and the second network mode are capable of being in the inactive state simultaneously, and wherein the controller is configured to:
switch a mode of the controller from an active mode to a sleep mode when the first network mode and the second network mode are simultaneously in the inactive state.

5. The wireless device of claim 4, wherein when one of the first network mode and the second network mode initiates switching from the inactive state to the connected state, the controller is configured to:
switch a mode of the controller from the sleep mode to the active mode, and wherein after switching to the active mode the controller switches one of the first network mode and the second network mode from the inactive state to the connected state.

6. The wireless device of claim 5, further comprising:
a memory configured to store at least one of first network data and first modem configuration associated with the first network and second network data and second modem configuration associated with the second network.

7. The wireless device of claim 6, wherein before switching to the sleep mode, the controller is configured to store at least one of the first network data, the first modem configuration, the second network data, and the second modem configuration in the memory.

8. The wireless device of claim 6, wherein the memory is a flash memory.

9. The wireless device of claim 6, wherein before switching to the active mode, the controller is configured to retrieve at least one of the first network data, the first modem configuration, the second network data, and the second modem configuration from the memory.

10. The wireless device of claim 1, wherein the controller is further configured to:
provide a connected state schedule of the second network mode to the first network mode.

11. The wireless device of claim 10, wherein the first network mode is configured to provide the connected state schedule of the second network mode to a scheduler of the first network, and
wherein the scheduler of the first network is configured to schedule, based on the connected state schedule of the second network mode, a connected state schedule of the first network mode such that the connected state of the first network mode and the connected state of the second network mode are non-overlapping.

12. The wireless device of claim 1, further comprising:
a set of shared resources, wherein the network modem in the first network mode is further configured to access the set of shared resources to connect with the first network, and wherein the network modem in the second network mode is further configured to access the set of shared resources to connect with the second network, and
wherein the controller is configured to non-simultaneously grant access of the set of shared resources to the network modem to connect with the first network and the second network.

13. A method of operating a wireless device comprising a controller and a network modem that is connectable with a first network and a second network, the method comprising:
connecting either the network modem in a first network mode with the first network or the network modem in a second network mode with the second network;
controlling, by the controller of the wireless device, a connected state and an inactive state of the first network mode and the second network mode;
switching the first network mode from the inactive state to the connected state when the second network mode is in the inactive state; and
switching the second network mode from the inactive state to the connected state when the first network mode is in the inactive state.

14. The method of claim 13, wherein the first network is a terrestrial network, the second network is a non-terrestrial network, and wherein the wireless device is a user equipment.

15. The method of claim 13, wherein the first network mode and the second network mode are capable of being in the inactive state simultaneously, the method further comprising:
switching, by the controller, a mode of the controller from an active mode to a sleep mode when the first network mode and the second network mode are simultaneously in the inactive state.

16. The method of claim 15, further comprising:
switching, by the controller, the mode of the controller from the sleep mode to the active mode when one of the first network mode and the second network mode initiates switching from the inactive state to the connected state,
wherein after switching to the active mode the controller switches one of the first network mode and the second network mode from the inactive state to the connected state.

17. The method of claim 16, further comprising:
storing, by a memory of the wireless device, at least one of first network data and first modem configuration associated with the first network and second network data and second modem configuration associated with the second network.

18. The method of claim 17, further comprising:
storing, by the controller before switching to the sleep mode, at least one of the first network data, the first modem configuration, the second network data, and the second modem configuration in the memory; and
retrieving, by the controller before switching to the active mode, at least one of the first network data, the first modem configuration, the second network data, and the second modem configuration from the memory.

19. The method of claim 13, further comprising:
providing, by the controller, a connected state schedule of the second network mode to the first network mode;
providing, by the first network mode, the connected state schedule of the second network mode to a scheduler of the first network; and
scheduling, by the scheduler of the first network based on the connected state schedule of the second network mode, a connected state schedule of the first network mode such that the connected state of the first network mode and the connected state of the second network mode are non-overlapping.

20. The method of claim 13, further comprising:
accessing, by the network modem in the first network mode, a set of shared resources to connect with the first network;
accessing, by the network modem in the second network mode, the set of shared resources to connect with the second network; and
granting, by the controller, access of the set of shared resources to the network modem to connect with the first network and the second network non-simultaneously.
